(19) United States
(12) Patent Application Publication
(10) Pub. No.: US 2016/0313491 A1
(43) Pub. Date: Oct. 27, 2016

(54) ILLUMINATION STRUCTURE FOR USE WITH FRONTLIGHT

(71) Applicant: QUALCOMM MEMS Technologies, Inc., San Diego, CA (US)

(72) Inventors: Kebin Li, Fremont, CA (US); Peter Lien, Carlsbad, CA (US); Jian Ma, San Diego, CA (US)

(21) Appl. No.: 14/696,062

(22) Filed: Apr. 24, 2015

(51) Int. Cl. F21V 8/00; G09G 3/20; G09G 3/34

(52) U.S. Cl. CPC G02B 6/0026; G02B 6/0031; G02B 6/0036; G02B 6/0085; G02B 6/0083; G02B 6/0073; G02B 6/0065; G09G 3/3406; G09G 3/2003; G09G 2320/062; G09G 2330/023; G09G 2360/144

(57) ABSTRACT

This disclosure provides systems, methods and apparatus for increasing the uniformity of illumination provided by frontlight systems using multiple discrete light sources. In one aspect, a phosphor material can be disposed between the discrete light sources and a light-turning waveguide, so that at least some of the light emitted by the discrete light sources is absorbed and re-emitted by the phosphor material. The light re-emitted by the phosphor material can have a more diffuse directional profile than the light emitted by the discrete light sources, and injecting this more diffuse light into the waveguide can reduce optical effects which provide non-uniform illumination across the waveguide.

### TECHNICAL FIELD

This disclosure relates to frontlight systems, and in particular frontlight systems which can be used alone or in conjunction with reflective displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in an illumination system including a waveguide configured to turn light propagating within the waveguide out of the waveguide, and an illumination structure arranged adjacent an edge of the waveguide and configured to inject light into the waveguide, the illumination structure including a plurality of discrete light sources arranged in a linear array along the edge of the waveguide, and a phosphor material disposed between the plurality of discrete light sources and the edge of the waveguide.

In some implementations, the plurality of discrete light sources can include a plurality of light-emitting diodes (LEDs). In some further implementations, the plurality of LEDs can include a plurality of blue LEDs, and the phosphor material can include a yellow phosphor material.

In some implementations, the illumination structure can include reflective surfaces configured to direct light emitted by the plurality of discrete light sources and the phosphor material to the edge of the waveguide. In some further implementations, the reflective surfaces can substantially surround the plurality of discrete light sources and the phosphor material except for the section of the phosphor material adjacent the edge of the waveguide. In some implementations, the waveguide can include a plurality of light-turning features configured to turn light out of the waveguide, the plurality of light-turning features including frustoconical depressions formed in a major planar surface of the waveguide.

In some implementations, the illumination structure can include a support substrate, the support substrate including a first section extending beyond the edge of the phosphor material and adjacent a major planar surface of the waveguide. In some further implementations, the system can include an adhesive disposed between the major planar surface of the waveguide and the first section of the support substrate to secure the illumination structure relative to the waveguide. In some further implementations, the support substrate can additionally include a second section extending in the opposite direction of the first section and beyond the edge of the plurality of discrete light sources. In some still further implementations, the second section can support a plurality of heat-dissipating structures. In some still further implementations, the second section can support a plurality of connection pads in electrical communication with the plurality of discrete light sources.

Another innovative aspect of the subject matter described in this disclosure can be implemented in an illumination system including a waveguide configured to turn light propagating within the waveguide out of the waveguide, and an illumination structure arranged adjacent an edge of the waveguide and configured to inject light into the waveguide, the illumination structure including a plurality of discrete light sources arranged in a linear array along the edge of the waveguide and configured to emit light, and means for absorbing and re-emitting at least a portion of light emitted by the plurality of discrete light sources, wherein the re-emitted light is re-emitted in a more diffuse manner than the light emitted by the plurality of discrete light sources.

In some implementations, the re-emitted light can be re-emitted at a different wavelength than the wavelength of light emitted by the plurality of discrete light sources. In some implementations, the absorbing and re-emitting means can include a phosphor material disposed between the plurality of discrete light sources and the edge of the waveguide. In some further implementations, the plurality of discrete light sources can include a plurality of blue LEDs, and the phosphor material can include a yellow phosphor material.

Another innovative aspect of the subject matter described in this disclosure can be implemented in an illumination structure including a light-emitting assembly including a linear array of discrete light sources, and a phosphor material disposed adjacent the linear array of discrete light sources, and one or more reflective surfaces substantially surrounding the light-emitting assembly, wherein an exposed portion of the phosphor material is not covered by the one or more reflective surfaces.

In some implementations, the illumination structure can additionally include a support substrate extending beyond the edge of the light-emitting assembly to form at least one shelf. In some further implementations, the at least one shelf can extend beyond side of the light-emitting assembly on the same side as the exposed portion of the phosphor material and includes an adhesive material. In some further implementations, the at least one shelf can extend beyond the side of the light-emitting assembly opposite the exposed portion of the phosphor material and includes one of a heat-dissipating structure or a connection pad in electrical communication with the linear array of discrete light sources.

Another innovative aspect of the subject matter described in this disclosure can be implemented in a method of fabricating an illumination system, the method including disposing phosphor material adjacent a plurality of discrete light sources, surrounding the plurality of discrete light sources and the phosphor material by reflective surfaces, except for an exposed portion of the phosphor material, and disposing the exposed portion of the phosphor material adjacent an edge of a waveguide, the waveguide configured to constrain light propagating therein and including light-turning features configured to turn light out of the waveguide.

In some implementations, the plurality of discrete light sources can include a plurality of blue LEDs, and wherein the phosphor material includes a yellow phosphor. In some implementations, the plurality of discrete light sources can be supported by a reflective printed circuit board (PCB). In some implementations, the waveguide can include a plurality of light-turning features configured to turn light out of the waveguide, the plurality of light-turning features including frustoconical depressions formed in a major planar surface of the waveguide

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a side cross-section of an example of a frontlight system configured to turn incident light out of plane of the frontlight system.

FIG. 1B shows a top plan view of the frontlight system of FIG. 1A, illustrating optical effects which can result from direct injection of light via discrete light sources.

FIG. 1C shows a top plan view of the frontlight system of FIG. 1A, illustrating optical effects which can result from imperfections at the edge of the frontlight system.

FIG. 2A shows a side cross-section of another example of a frontlight system including a phosphor material disposed between the light sources and the waveguide.

FIG. 2B shows a top plan view of the frontlight system of FIG. 2A.

FIG. 3A is a perspective view of an illumination structure such as the illumination structure of the frontlight system of FIG. 2A, shown from behind.

FIG. 3B is a rear view of the illumination structure of FIG. 3A.

FIG. 3C is a perspective view of the illumination structure of FIG. 3A, shown from the front.

FIG. 4 is a flow diagram illustrating a fabrication process for a frontlight system including a phosphor material.

FIG. 5 is a cross-sectional view of a reflective display device utilizing a frontlight system including the illumination structure of FIGS. 3A through 3C.

FIG. 6 is an isometric view illustration depicting two adjacent interferometric modulator (IMOD) display elements in a series or array of display elements of an IMOD display device.

FIGS. 7A and 7B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In order to illuminate a reflective display or other object, a frontlight system can be disposed over the object to be illuminated. Light can be injected into a waveguide from the side, propagating within the light-guiding film until it strikes a light-turning feature and is reflected downward and out of the waveguide to illuminate an underlying object. In some implementations, the frontlight system may include a plurality of discrete light sources such as LEDs. When a plurality of discrete light sources inject light directly into the waveguide, the distribution of light emitted by the discrete light sources can create multiple types of optical effects which impact the appearance and operation of the frontlight system. The frontlight system may provide uneven illumination along the edge of the waveguide adjacent the light sources. The angular distribution of light can amplify the optical effect of scribing imperfections or other imperfections in the waveguide. By disposing a diffuser layer between the light sources and the waveguide, these optical effects can be reduced or eliminated.

Particular implementations of the subject matter described in this disclosure can be implemented to realize one or more of the following potential advantages. When a continuous strip of phosphor material is disposed between the discrete light sources and the waveguide, the angular profile of the light passing through and re-emitted by the phosphor material will be more diffuse and uniform than the original angular profile of the emitted light from an array of discrete light sources. The phosphor material can alter the wavelength of emitted light by re-emission of absorbed light at a different wavelength. For example, a combination of blue LEDs and yellow phosphor can be used to generate white light. The diffusing properties of the phosphor will reduce or eliminate variations in brightness over the waveguide, such as hot spots or areas of increased brightness adjacent the LEDs and other optical artifacts which can result when the waveguide includes a scribed glass layer or similar component which can include microfractures at the edges, or other manufacturing irregularities.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber. Other reflective display devices can include, for instance, reflective liquid crystal displays (LCDs) and e-ink displays.

In certain implementations, frontlight systems can be used to provide primary or supplemental illumination for a display device or other object to be illuminated. In particular, reflective display devices such as interferometric modulator-based devices or other electromechanical system (EMS) devices may utilize frontlight systems for illumination due to the opacity of the EMS devices. While a reflective display such as an interferometric modulator-based display may in some implementations be visible in ambient light, some particular implementations of reflective displays may include supplemental lighting in the form of a frontlight system,

In some implementations, a frontlight system may include one or more waveguides or light-guiding layers through which light can propagate, and one or more light-turning features to direct light out of the waveguide. Light can be injected into the waveguide, and light-turning features can be used to reflect light within the waveguide towards a reflective display or other object to be illuminated, and be reflected back in turn through the waveguide towards a viewer. Until light reaches a light-turning feature, the injected light may propagate within the waveguide via total internal reflection, so long as the material of the waveguide has an index of refraction greater than that of the surrounding layers and the conditions for total internal reflection (TIR) are satisfied. Such a frontlight system allows an illuminating light source to be positioned at a location offset from the display or other object to be illuminated, such as at one of the edges of the frontlight system.

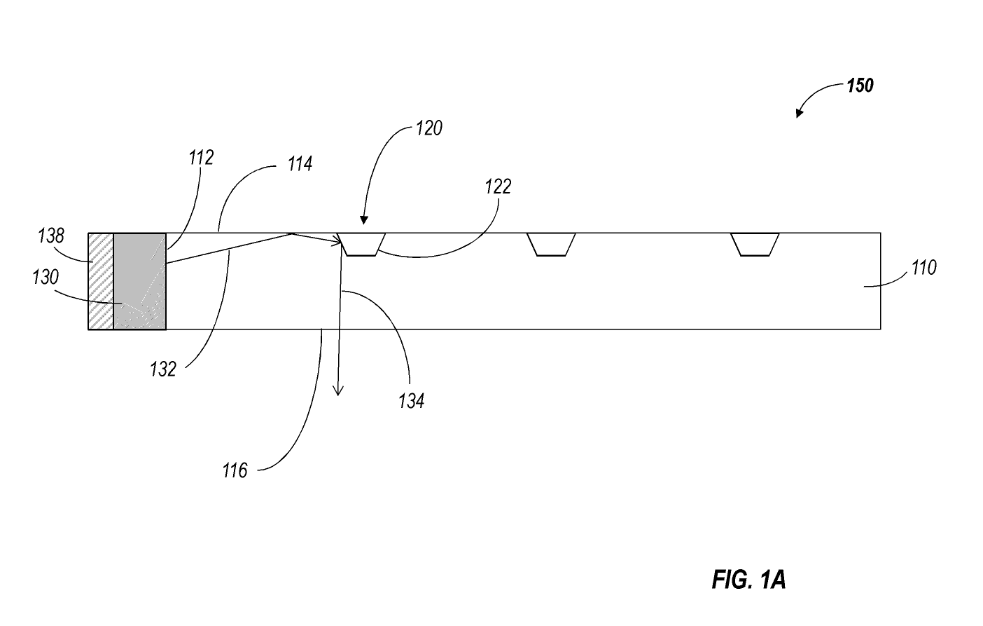

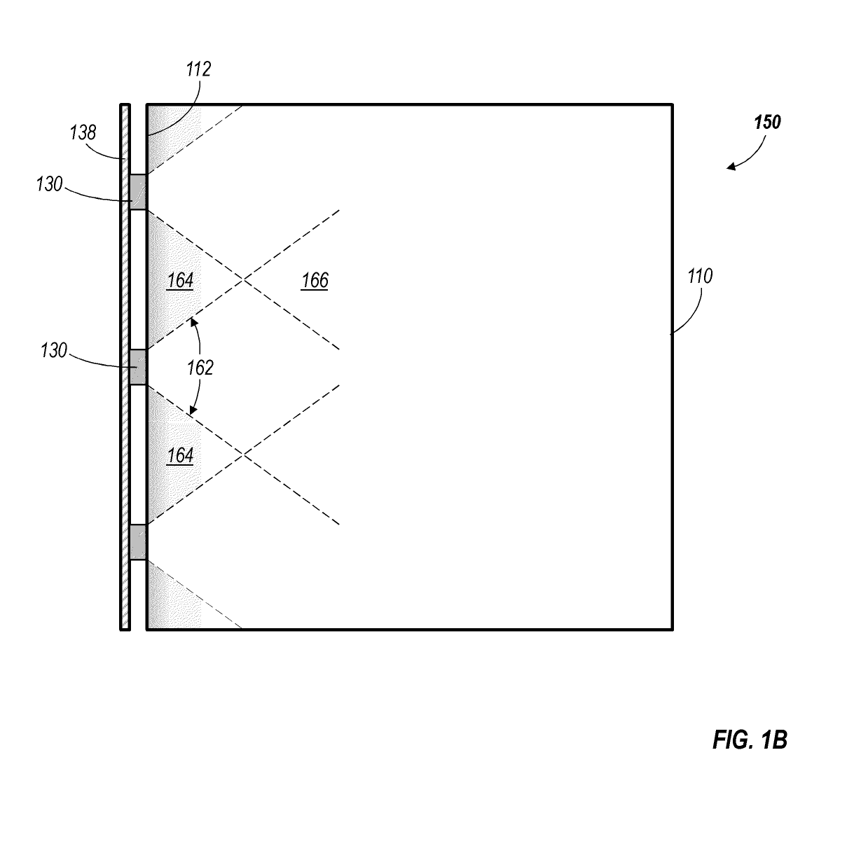

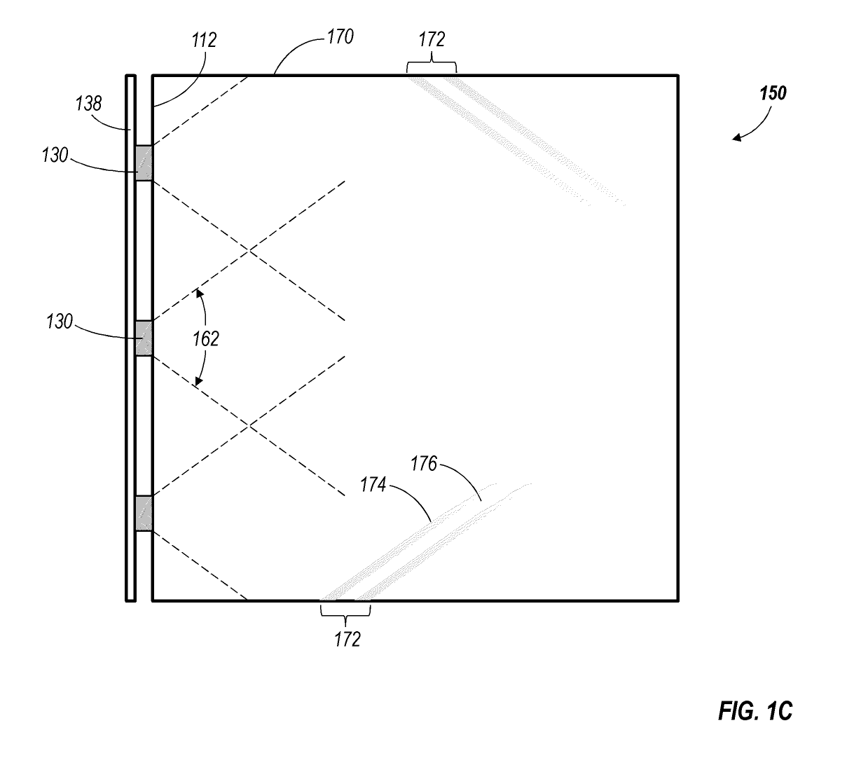

FIG. 1A shows a side cross-section of an example of a frontlight system configured to turn incident light out of plane of the frontlight system. Although one particular implementation of a frontlight system is shown, the implementations described herein can be used in conjunction with any suitable frontlight or backlight systems which includes a waveguide into which light is coupled. The frontlight system 150 includes a waveguide 110 which may have an index of refraction greater than air or any surrounding layers, as discussed above. The waveguide 110 also may include a plurality of light-turning features 120 disposed along an upper surface 114 of the waveguide 110.

These light-turning features 120 include a depression formed in the waveguide 110. The depression may be conical or frustoconical in shape, with the angled sidewall 122 of the depression oriented at an angle to the upper surface 114 and lower surface 116 of light-guiding layer 110. In the illustrated implementation, light can be reflected by total internal reflection at the angled sidewall 122 of the depression, but in other implementations, a reflective layer may be formed over a depression of light-turning feature 120, and a masking layer may be formed on the opposite side of the reflective layer from the waveguide 110 to shield reflections from the viewer. Although illustrated for simplicity without a reflective layer, the various implementations described herein may also be used in conjunction with a reflective layer, and may be used in conjunction with any other suitable frontlight or backlight system.

The frontlight system 150 includes a light source 130 which injects light ray 132 into the waveguide 110. The injected light ray 132 propagates by means of total internal reflection as shown until it strikes an angled sidewall 122 of a light-turning feature 120. The light ray 134 reflected off the angled sidewall 122 of the light-turning feature 120 is turned downwards towards lower surface 116 of the light-guiding layer 110. When the light ray 134 is reflected in a direction sufficiently close to the normal of the lower surface 116 of waveguide 110, the light ray 134 passes through the lower surface 116 of waveguide 110 without being reflected back into the waveguide 110. The light source 130 may be supported by a printed circuit board (PCB) 138 or other supporting structure (such as a flexible electrical connector), which can provide both mechanical support and electrical connection to the light source 130.

In the illustrated implementation, the reflection or transmission of light reaching the angled surfaces of similar light-turning features may be dependent on the angle at which the light 132 is incident upon an angled sidewall 122 of a light-turning feature 120. In contrast, in implementations in which the light-turning features include a reflective layer, all light incident upon the reflective layer will be reflected downwards towards lower surface 116 of the waveguide 110. The use of a reflective layer can therefore reduce light leakage from light-turning features 120, improving the efficiency of the frontlight system 150 as a larger amount of light can be directed downward and towards a reflective display or other object to be illuminated.

Although referred to for convenience as a single layer, the waveguide 110 may in some implementations be a multilayer structure formed from layers having indices of refraction sufficiently close to one another that the waveguide 110 generally functions as a single layer, with minimal refraction and/or total internal reflection between the various sublayers of the waveguide film 110.

The frontlight system 150 thus redirects light 132 propagating within the light-guiding layer downward through the lower surface 116 of the waveguide 110. As illustrated in FIG. 1A, the frontlight system relies on the interface between air and the planar sections of the upper surface 114 and the lower surface 116 of frontlight film 110 to constrain light 134 propagating within the frontlight film 110 via total internal reflection (TIR). However, a frontlight system is often used as part of a multilayer structure, and contact between the frontlight film 110 and an adjacent high-index material may frustrate the total internal reflection and prevent the frontlight system 150 from operating as intended.

FIG. 1B shows a top plan view of the frontlight system of FIG. 1A, illustrating optical effects which can result from direct injection of light via discrete light sources. As can be seen in FIG. 1B, the light source 130 of FIG. 1A may be one in a linear array of discrete light sources 130 spaced apart from one another along the length of edge 112 of waveguide 110. The light sources 130 may be, for example, a plurality of LEDs arranged along the length of a single PCB 138 or other supporting substrate. In other implementations, however, the light sources 130 may be supported by multiple non-contiguous substrates.

In an implementation in which the light sources 130 are LEDs or similar light sources, the light sources 130 may emit light in generally conical shape 162, with a greater concentration of light emitted at angles in front of the light sources 130, and a smaller amount of light emitted at angles to the sides of the light sources 130. In some implementations, light emitted into a waveguide 110 by LEDs will have a substantial percentage of the injected light at angles within roughly 42° of an axis extending directly outward from the LEDs, forming a conical shape 162 within which a substantial amount of the light emitted by light sources 130 is located. The exact angle of the conical shape 162 may be dependent on a variety of factors, including the particular light source 130 used, and the indices of refraction of the materials such as waveguide 110 through which the light passes, as refraction at the boundaries will affect the direction of the injected light.

The amount of light propagating within of the waveguide 110 may thus vary across the waveguide 110 due to the directionality of light directly injected into the waveguide 110. In an implementation in which the density of light turning features 120 is substantially constant across the waveguide 110, or substantially constant for a given distance from the injection edge 112 of the waveguide, variances in the amount of light propagating within the waveguide 110 will result in a similar variance in the amount of light turned out of the waveguide 110, leading to an uneven illumination pattern across the waveguide 110. This discrepancy may be most notable in the area of the waveguide 110 immediately adjacent the injection edge 112 of the waveguide 110.

As can be seen in FIG. 1B, the conical light output areas 162 where the light output from the discrete light sources 130 is most concentrated may be generally evenly illuminated, but the underilluminated areas 164 of the frontlight system 150 immediately adjacent the injection edge 112 of the waveguide 110 which are not within the conical light output areas 162 will appear comparatively darker. As little or no light emitted from the light sources 130 will be propagating within these underilluminated areas 164, little or no light will be turned out of the waveguide 110 by light-turning features 120 within the underilluminated areas, causing them to appear darker and giving a crosshatched appearance to the illumination pattern of the frontlight system 150 in the area adjacent the injection edge of the frontlight system. Similarly, areas 166 at which the conical light output areas 162 overlap may appear comparatively brighter in the areas close to the injection edge 112 of the waveguide 110, yielding an uneven illumination pattern along the injection edge 112 of the waveguide 110.

In some implementations, this uneven illumination pattern can be hidden or otherwise reduced while still utilizing discrete light sources 130 which directly inject light into the waveguide 110. For example, the area immediately adjacent the injection edge 112 of the waveguide 110 may be masked with a bezel or other light-blocking structure. However, doing so will increase the overall footprint of the display in order to maintain the same visible display area. In other implementations, the number of discrete light sources 130 can be increased, reducing the distance between the light sources and reducing the size of the underilluminated areas 162. However, the addition of additional light sources 130 can add to the cost and complexity of the frontlight system 150.

FIG. 1C shows a top plan view of the frontlight system of FIG. 1A, illustrating optical effects which can result from imperfections at the edge of the frontlight system. In addition to illuminating the frontlight system 150 in an uneven pattern, the conical light output areas 162 resulting from direct injection of light from light sources 130 also result in the ray angles of the injected light being concentrated within specific ranges of ray angles. Because of this concentration of light at specific ray angles, imperfections in the waveguide 110 can generate streak effects in the illumination pattern of the frontlight system 150. As can be seen in FIG. 1C, the side edges 170 of the waveguide 110 may include areas 172 with imperfections in the edge surface. These areas 172 of imperfections may include cracks, microfractures, jagged edges, grooves, or any other features which can disrupt the reflection of injected light at the edges 170 of the waveguide 110. In some implementations, these areas 172 of imperfection may occur during a scribing process or other fabrication process which forms the waveguide 110. Because of the concentration of light within a band of specific ray angles, light reflected at these areas 172 of imperfections will be unevenly reflected, leading to streak effects in illumination pattern in the form of darker streaks 174 and brighter streaks 176.

In some implementations, these streak effects may be reduced or eliminated by grinding the edges 170 of the waveguide 110 to reduce or eliminate areas 172 of imperfections. Doing so will reduce or eliminate the presence of streak effects, but will add to the cost and complexity of the fabrication process. Because both the streak effects illustrated in FIG. 1C and the cross-hatched illumination pattern illustrated in FIG. 1B are due in part to direct injection of the light into waveguide 110 by light sources 130, an alternative to direct injection of light can also be used to reduce or eliminate these optical effects.

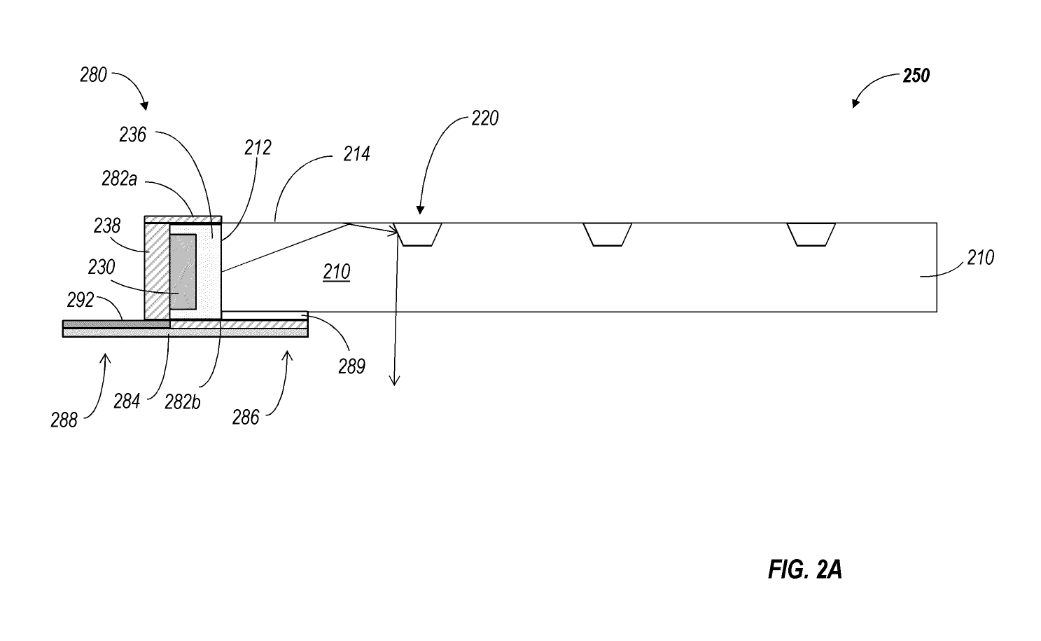

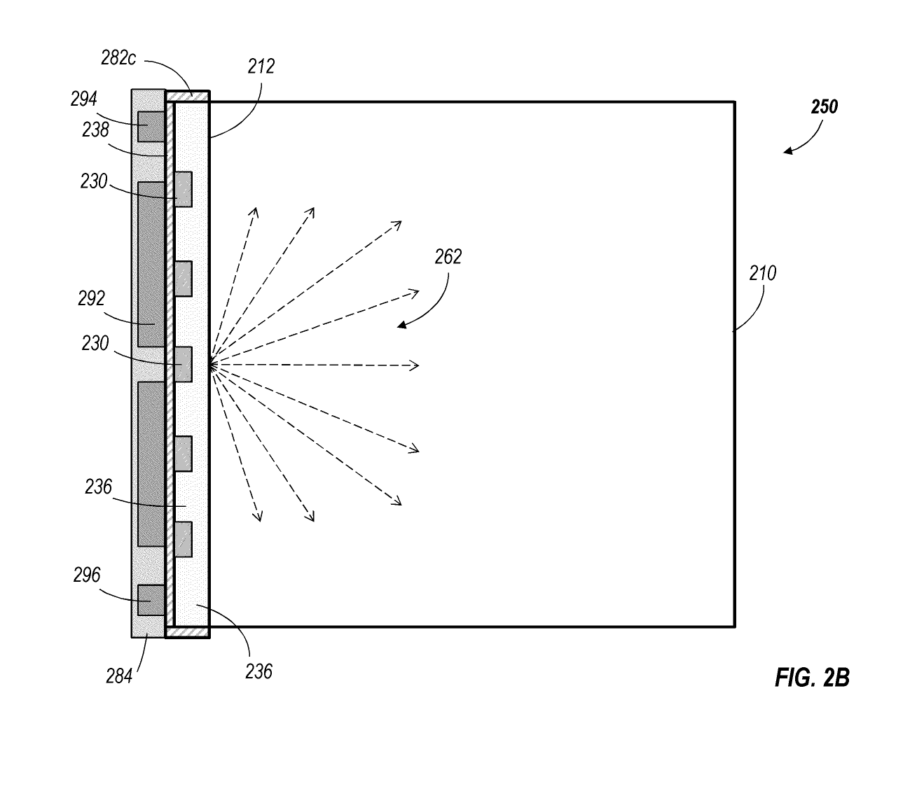

FIG. 2A shows a side cross-section of another example of a frontlight system including a phosphor material disposed between the light sources and the waveguide. The frontlight system 250 is similar to the frontlight system 150 of FIG. 1A, and includes a light source 230 disposed near an injection edge 212 of a waveguide 210. Light turning features 220 in the top surface 214 of the waveguide 210 turn light downward and out of the waveguide 210 to illuminate an underlying display or other object. In contrast to the frontlight system 150 of FIG. 1A, however, the light from light source 230 is not directly injected into the waveguide 210.

Rather, the light source 230 is disposed within an illumination structure 280 positioned at the injection edge 212 of the waveguide 210. The illumination structure 280 includes phosphor material 236 disposed between the light source 230 and the injection edge 212 of the waveguide 210. In the illustrated implementation, the phosphor material 236 is a continuous linear strip of phosphor material 236. At least a portion of light emitted by light source 230 is absorbed by the phosphor material 236, energizing the phosphor material 236 and causing the energized phosphor material 236 to emit light into the injection edge 212 of the waveguide 210. The directionality of light emitted by the phosphor material 236 is independent of the directionality of the light which energizes the phosphor material 236, and the energized phosphor material 236 will emit light in a diffuse pattern, unlike the conical emission pattern of a light source such as an LED. Disposing a phosphor material 236 between the light source 230 and the waveguide 210 can reduce the directionality of light injected into the waveguide 210. Thus, the phosphor material 236 can provide means for absorbing and re-emitting at least a portion of light emitted by the light source 230. This re-emitted light is re-emitted with a more diffuse directional profile than the light emitted by the light source 230.

In addition, the wavelengths of light emitted by the energized phosphor material 236 is independent of the wavelengths of light emitted by the light source 230 which energizes the phosphor material 236. The phosphor material 236 may be selected to emit wavelengths of light which combine with the wavelengths of light emitted by the light source 230 to provide a desired overall light output. In some implementations, the light source 230 may be a blue LED, or another light source which emits a substantial percentage of its visible light output at wavelengths less than 460 nm, and the phosphor material 236 may be a yellow phosphor. The combination of yellow light emitted by the energized phosphor material 236 and blue light which passes through the phosphor material 236 without being absorbed by the phosphor material 236 can be substantially white light, and in some implementations may be close to daylight, such as D65 white light or similar.

The illumination structure 280 can also include a reflective PCB 238 or similar structure supporting the light source 230. A layer of reflective material 282a may overlie the phosphor material 236 and light source 230 and a layer of reflective material 282b may similarly underlie the phosphor material 236 and light source 230, prevent light leakage from the top or bottom of the illumination structure 280 and increasing the amount of light injected through the injection edge 212 of the waveguide 280. The illumination structure may include a structural member such as a support substrate 284 which may extend beyond the edges of the light source 230 and phosphor material 236, and may provide one or both of a front shelf 286 extending adjacent part of the waveguide 210 and a rear shelf 288 extending in the opposite direction.

The illumination structure may be adhered to the waveguide 210 using an adhesive 289 such a pressure-sensitive adhesive applied to one or both of the top surface 214 or bottom surface 216 of the waveguide 210, although in other implementations other securement methods may be used. In the illustrated implementation, the adhesive 289 is disposed between the waveguide 210 and an extension of the lower layer of reflective material 282b. By extending the layer of reflective material 282b, any suitable material can be used as the structural support substrate 284 without affecting the performance of the frontlight system 250. In other implementations, the layer of reflective material 282b may serve as sufficient structural support, without the need for a separate support substrate 284. The rear shelf 288 of the illumination structure 280 can support additional components, such as a heat-dissipation structure 292 in the form of a metal pad or similar structure.

FIG. 2B shows a top plan view of the frontlight system of FIG. 2A. As can be seen in FIG. 2B, the light 262 emitted by the energized phosphor material 236 is emitted substantially evenly across a wide range of angles. The illumination of the frontlight system 250 will be more even than the illumination of the frontlight system 150 depicted in FIGS. 1A and 1B, and will reduce or eliminate the optical effects depicted and described with respect to those figures. Because of the diffuse nature of the light 262 emitted from the energized phosphor material 236, the illumination may be made substantially uniform even though there may be variations in the amount of light emitted by the phosphor material 236 across the length of the phosphor material 236.

As the sections of the phosphor material 236 in front of or closer to the light sources 230 may be more energized and emit more light than the sections of the phosphor material 236 between the light sources 230, the diffuse nature of the emitted light 262 will reduce the under-illuminated appearance of the sections of frontlight 250 adjacent the injection edge 212 and between the discrete light sources 230. This reduction in illumination variance can be further improved by increasing the number of discrete light sources 230, if desired. In order to provide more even light injection across the injection edge 212 of the waveguide 212, a light-shaping structure such as a linear diffuser (not shown), which may include a row of lenticular structures, can be used to spread light within the plane of the waveguide 210. Such a light-shaping can be disposed between the phosphor material 236 and the waveguide 210, and can be used to reduce the distance by which the light source is set back from the injection edge 212 in order to provide even illumination throughout the frontlight system 250.

As can also be seen in FIG. 2B, the rear shelf 288 of the illumination structure 280 can be used to support connection pads and other functional components of the illumination structure 280. For example, the rear shelf 288 may support heat sinks in the form of metal layers 292 or other passive or active cooling components, in order to dissipate at least some of the heat generated by the light sources 230 or other components of the illumination structure 280. In some implementations, the metal layers 292 may be substantially flat, while in other implementations fins or similar heat-transfer surfaces may be included. The rear shelf 288 may also support an anode 294 and a cathode 296 to provide electrical communication with light sources 230 and any other components of the illumination structure 280, such as integrated circuits (ICs) or other component supported by the PCB 238. Reflective surfaces 282c may also be provided at the ends of the illumination structure 280, so that the phosphor material 236 may be surrounded by reflective material on all sides except the side facing the injection edge 212 of the waveguide 210. This reflective material 282c surrounding the phosphor 236 and light sources 230 will increase the amount of light injected into the waveguide 210.

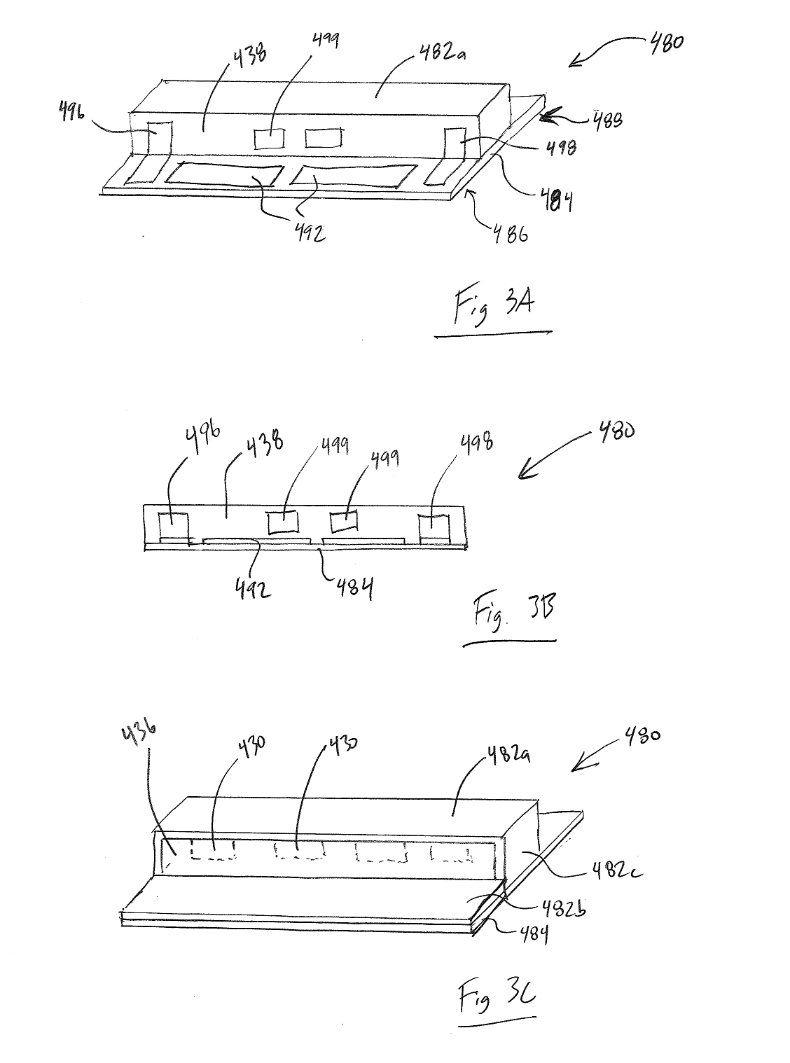

FIG. 3A is a perspective view of an illumination structure such as the illumination structure of the frontlight system of FIG. 2A, shown from behind. FIG. 3B is a rear view of the illumination structure of FIG. 3A. It can be seen in FIG. 3A that the illumination structure 480 includes an anode 494 and the cathode 496 which in the illustrated implementation are contiguous L-shaped structures which extend over portions of both the rear shelf 488, as well as rear surface of PCB 438. In other implementations, the anode 494 and cathode 496 may be located on only one of the rear shelf 488 or PCB 438. As can be seen in FIGS. 3A and 3B, the PCB 438 may also include connection pads 499, which can also be used to provide power, control, or other electrical communication with the light sources 430 supported by the PCB 438 or any other structure supported by or in electrical communication with the PCB 438.

In some implementations, the support substrate 484 may also be a printed circuit board or similar structure. In some implementations in which the support substrate 484 is a printed circuit board or similar structure, the light sources 430 may be supported from below by this PCB, rather than being supported from behind by PCB 438, and PCB 438 may be replaced with a reflective surface. In other implementations in which the support substrate 484 is a printed circuit board or similar structure, the light sources 430 may be supported by a second PCB 438 or die structure, which can be oriented at an angle to the underlying PCB which forms support substrate 484.

FIG. 3C is a perspective view of the illumination structure of FIG. 3A, shown from the front. As can be seen in FIG. 3C, the illumination structure includes a reflective layer 482b overlying the support substrate 484 in the front shelf area in front of the exposed surface of the phosphor material 436. In some implementations, however, the support substrate 484 may be made from or covered with a reflective material, such that a distinct reflective layer 482b need not be included. As discussed above, the plurality of light sources 430 shown in shadow behind the phosphor material 436 will emit light through the phosphor material 436, at least a portion of which will be absorbed by the phosphor material 436 and re-emitted in a diffuse manner at different wavelengths of light, providing a more even illumination at the edge of the phosphor material 436.

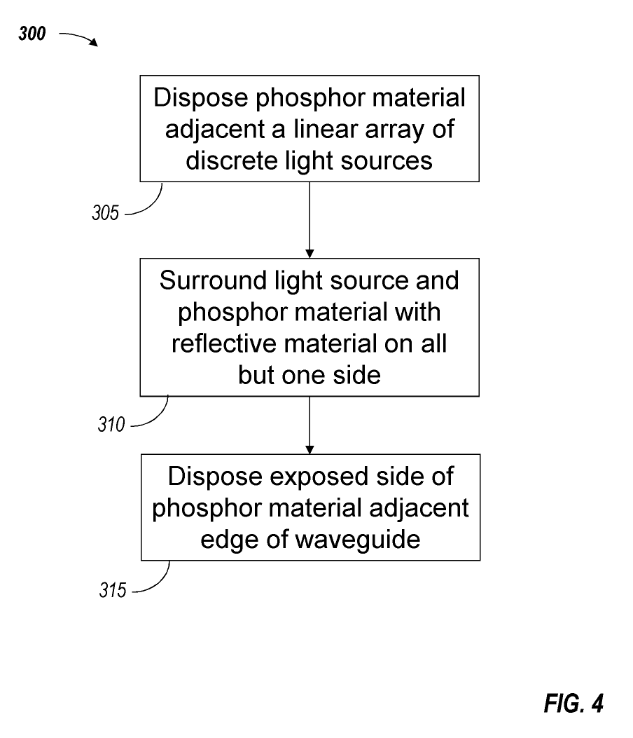

FIG. 4 is a flow diagram illustrating a fabrication process for a frontlight system including a phosphor material. In block 305 of the fabrication process 300, phosphor material is disposed adjacent a linear array of discrete light sources. In some implementations, as discussed above, the discrete light sources may be LEDs or any other suitable light source. In some particular implementations, the LEDs may be blue LEDs, and the phosphor material may be a yellow phosphor material, such that the emission of light through the LEDs may result in white light being emitted from the side of the phosphor material opposite the LEDs, In particular implementations, the LEDs may be blue LEDs, or LEDs which emit a substantial percentage of their light at wavelengths shorter than about 460 nm.

In block 310 of the fabrication process 300, the linear array of discrete light sources and the phosphor material are surrounded on all but one side by a reflective material. In some implementations, the exposed side of the phosphor material may be the side opposite the discrete light sources, while in other implementations a different side may be exposed. In some implementations, a portion of the reflective material surrounding the light source and the phosphor material includes a reflective PCB or die structure supporting the array of discrete light sources. is disposed within the distal end of the conduit. The light source may in some implementations be one or more discrete LEDs spaced apart from one another, although other appropriate light sources may also be used.

In block 315 of the fabrication process 300, the exposed side of the phosphor material is disposed adjacent an injection edge of a waveguide, to form a frontlight system. Light emitted by the plurality of discrete light sources will pass through the phosphor material, where at least a portion of the emitted light will be absorbed and re-emitted. Some combination of directly emitted light and re-emitted light will pass through the exposed edge of the phosphor material and into the edge of the waveguide where it will propagate within the waveguide. The waveguide may include a plurality of light-turning features configured to turn light propagating within the waveguide out of the waveguide to illuminate a reflective display or other object to be illuminated.

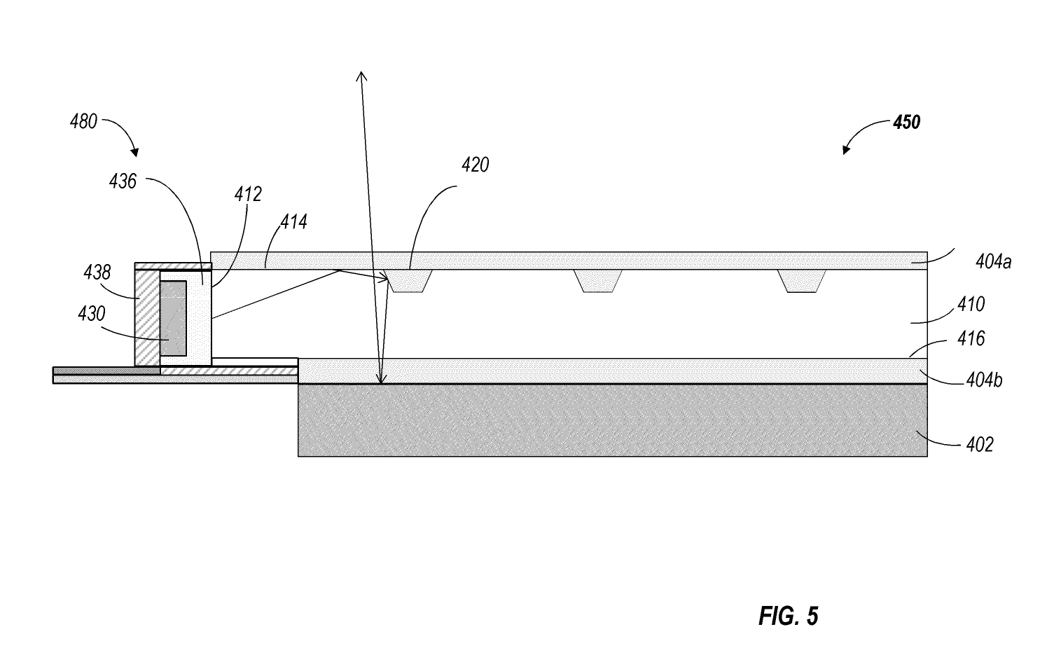

FIG. 5 is a cross-sectional view of a reflective display device utilizing a frontlight system including the illumination structure of FIGS. 3A through 3C. The reflective display device 450 includes the illumination system 480 of FIGS. 3A through 3C disposed adjacent an injection edge 412 of the waveguide 410. Light emitted from the light source 430 passes through the phosphor material 436 and into the waveguide 410, where it propagates by means of total internal reflection until it is reflected off of light-turning features 420 formed in or adjacent the upper surface 414 of the waveguide 410 and is turned outward through the lower surface 416 of the waveguide 410 and toward reflective display 402. The light is then reflected off of the reflective display 402 and back towards a viewer. To facilitate the total internal reflection of the light within the waveguide 410, the waveguide may be surrounded on both sides by an upper cladding layer 404a and a lower cladding layer 404b, each of which has an index of refraction lower than the index of refraction of the waveguide 410. In the illustrated implementation, the lower cladding layer 404b does not extend into the area covered by the lower shelf of the illumination structure 480, as a reflective surface within the lower shelf of the illumination structure 480 can ensure reflection of propagating light in that region. In other implementations, however, the lower shelf of the illumination structure may not include a reflective structure, and total internal reflection can be used to ensure propagation of light in this area, such as through the use of a low-index adhesive or through extension of the lower cladding layer 404b along the lower surface 416 of the waveguide 410 all the way to the injection edge 412.

Additional components may also be included in various implementations of display devices, such as an antireflective film, a touch-sensing system, and a protective cover glass. Although depicted as illuminating a reflective display, the above implementations of frontlight systems and components may be used to illuminate a wide variety of objects in addition to reflective displays. One non-limiting example of a reflective display type with which the frontlight systems and components described herein may be used is an interferometric modulator (IMOD) based display.

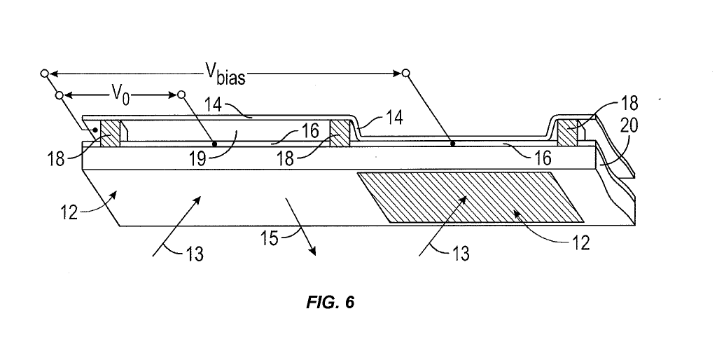

FIG. 6 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 6 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 6, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 6 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 6, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 6. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

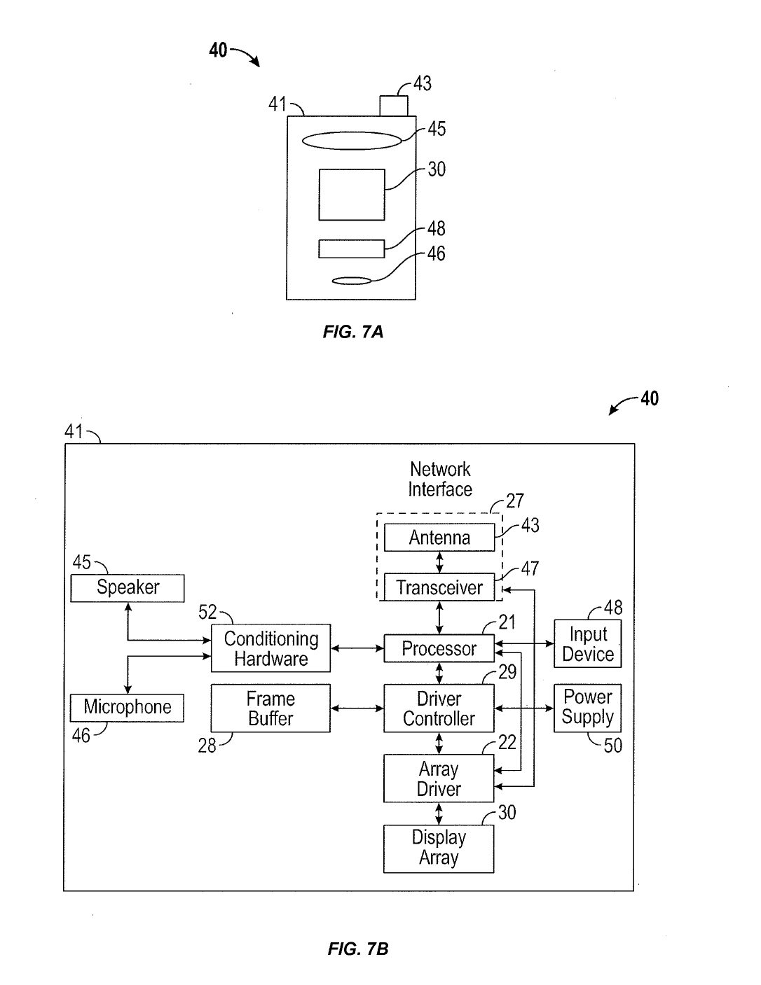

FIGS. 7A and 7B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 7A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system, comprising:
a waveguide configured to turn light propagating within the waveguide out of the waveguide; and
an illumination structure arranged adjacent an edge of the waveguide and configured to inject light into the waveguide, the illumination structure including:
a plurality of discrete light sources arranged in a linear array along the edge of the waveguide; and
a phosphor material disposed between the plurality of discrete light sources and the edge of the waveguide.

2. The system of claim 1, wherein the plurality of discrete light sources include a plurality of light-emitting diodes (LEDs).

3. The system of claim 2, wherein the plurality of LEDs include a plurality of blue LEDs, and wherein the phosphor material includes a yellow phosphor material.

4. The system of claim 1, wherein the illumination structure is configured to inject substantially white light into the waveguide.

5. The system of claim 1, wherein the plurality of discrete light sources are supported by a reflective printed circuit board.

6. The system of claim 1, wherein the illumination structure includes reflective surfaces configured to direct light emitted by the plurality of discrete light sources and the phosphor material to the edge of the waveguide.

7. The system of claim 6, wherein the reflective surfaces substantially surround the plurality of discrete light sources and the phosphor material except for the section of the phosphor material adjacent the edge of the waveguide.

8. The system of claim 1, wherein the waveguide includes a plurality of light-turning features configured to turn light out of the waveguide, the plurality of light-turning features including frustoconical depressions formed in a major planar surface of the waveguide.

9. The system of claim 1, wherein the illumination structure includes a support substrate, the support substrate including a first section extending beyond the edge of the phosphor material and adjacent a major planar surface of the waveguide.

10. The system of claim 9, additionally including an adhesive disposed between the major planar surface of the waveguide and the first section of the support substrate to secure the illumination structure relative to the waveguide.

11. The system of claim 9, wherein the support substrate additionally includes a second section extending in the opposite direction of the first section and beyond the edge of the plurality of discrete light sources.

12. The system of claim 11, wherein the second section supports a plurality of heat-dissipating structures.

13. The system of claim 11, wherein the second section supports a plurality of connection pads in electrical communication with the plurality of discrete light sources.

14. The system of claim 1, additionally including a reflective display, wherein the waveguide is configured to turn light towards the reflective display to illuminate the reflective display.

15. The system of claim 14, additionally including:
a processor that is configured to communicate with the reflective display, the processor being configured to process image data; and
a memory device that is configured to communicate with the processor.

16. The system of claim 15, additionally including:
a driver circuit configured to send at least one signal to the reflective display; and
a controller configured to send at least a portion of the image data to the driver circuit.

17. The system of claim 15, additionally including an image source module configured to send the image data to the processor, wherein the image source module comprises at least one of a receiver, transceiver, and transmitter.

18. The system of claim 15, additionally including an input device configured to receive input data and to communicate the input data to the processor.

19. An illumination system, comprising:
a waveguide configured to turn light propagating within the waveguide out of the waveguide; and
an illumination structure arranged adjacent an edge of the waveguide and configured to inject light into the waveguide, the illumination structure including:
a plurality of discrete light sources arranged in a linear array along the edge of the waveguide and configured to emit light; and
means for absorbing and re-emitting at least a portion of light emitted by the plurality of discrete light sources, wherein the re-emitted light is re-emitted in a more diffuse manner than the light emitted by the plurality of discrete light sources.

20. The illumination system of claim 19, wherein the re-emitted light is re-emitted at a different wavelength than the wavelength of light emitted by the plurality of discrete light sources.

21. The illumination system of claim 19, wherein the absorbing and re-emitting means include a phosphor material disposed between the plurality of discrete light sources and the edge of the waveguide.

22. The illumination system of claim 21, wherein the plurality of discrete light sources include a plurality of blue LEDs, and wherein the phosphor material includes a yellow phosphor material.

23. An illumination structure, including:
a light-emitting assembly including:
a linear array of discrete light sources; and
a phosphor material disposed adjacent the linear array of discrete light sources; and
one or more reflective surfaces substantially surrounding the light-emitting assembly, wherein an exposed portion of the phosphor material is not covered by the one or more reflective surfaces.

24. The illumination structure of claim 23, additionally including a support substrate extending beyond the edge of the light-emitting assembly to form at least one shelf.

25. The illumination structure of claim 24, wherein the at least one shelf extends beyond side of the light-emitting assembly on the same side as the exposed portion of the phosphor material and includes an adhesive material.

26. The illumination structure of claim 24, wherein the at least one shelf extends beyond the side of the light-emitting assembly opposite the exposed portion of the phosphor material and includes one of a heat-dissipating structure or a connection pad in electrical communication with the linear array of discrete light sources.

27. A method of fabricating an illumination system, comprising:
disposing phosphor material adjacent a plurality of discrete light sources;
surrounding the plurality of discrete light sources and the phosphor material by reflective surfaces, except for an exposed portion of the phosphor material; and
disposing the exposed portion of the phosphor material adjacent an edge of a waveguide, the waveguide configured to constrain light propagating therein and including light-turning features configured to turn light out of the waveguide.

28. The method of claim 27, wherein the plurality of discrete light sources includes a plurality of blue LEDs, and wherein the phosphor material includes a yellow phosphor.

29. The method of claim 27, wherein the plurality of discrete light sources are supported by a reflective printed circuit board (PCB).

30. The method of claim 27, wherein the waveguide includes a plurality of light-turning features configured to turn light out of the waveguide, the plurality of light-turning features including frustoconical depressions formed in a major planar surface of the waveguide.
